(19) United States
(12) Patent Application Publication
(10) Pub. No.: US 2010/0253105 A1
(43) Pub. Date: Oct. 7, 2010

(54) Jet Shovel

(76) Inventor: Marcel Nowakowski, Burnaby (CA)

Correspondence Address: Marcel Nowakowski, 315-3953 Godwin Ave., Burnaby, BC, V5G 4A1, CA

(21) Appl. No.: 12/384,460

(22) Filed: Apr. 6, 2009

(51) Int. Cl. A01D 11/06; A01B 1/22; F16L 3/00

(52) U.S. Cl. 294/51; 294/59; 138/106

(57) ABSTRACT

This disclosure relates to a fluid-pressure assisted shovel. The fluid-pressure assisted shovel reduces considerably the amount of force applied to the shovel while lifting it during an excavation process, especially during removing soil from deeper excavations. A quick burst of fluid, e.g. compressed air, accelerates the loaded shovel in the desired direction thereby reducing considerably the amount of force applied to the shovel by the digger.

### BACKGROUND OF THE INVENTION

1. Technical Field

The present invention relates to a shovel actuated by fluid movement. More specifically, the invention relates to a fluid-flow actuated shovel for moving soil and rocks and removal thereof from deeper excavations.

2. Description of Related Art

Usually, when there is a need to excavate by hand the process is being accomplished by digging trenches or holes in the ground using traditional hand-held shovels powered only by the strength of human muscles. It involves a great deal of physical exertion on the part of a digger and—as time passes—a considerable decline in productivity. The repetitive movement and strain from the loads of lifted soil cause considerable stress on the body, resulting often in injuries, especially pulled muscles and injuries of the lower back.

### BRIEF SUMMARY OF THE INVENTION

The present invention relates to a shovel adapted to move soil and rocks with much less physical effort than by doing the same by conventional means.

The jet shovel comprises a handle, a shovel blade, a shovel blade holder next to the handle, one or two valves at opposite ends of the handle to control the fluid flow through a conduit run alongside or inside the said shovel handle, a fluid conduit outlet nozzle directed away from the shovel blade, placed in the immediate proximity thereof.

In order to operate the present invention an external fluid-power source—usually compressed air—must be connected to the inlet valve. Opening of the valve causes rapid fluid flow through the conduit. The jet of fluid exiting the outlet nozzle exerts a force that pushes the shovel-blade end of the invention in the direction opposite to the flow of the fluid exiting the nozzle.

The principal object of the invention is to provide a shovel that does away with tiresome digging practices and enhances productivity.

### BRIEF SUMMARY OF THE INVENTION

Another object of the invention is to limit injuries—especially to the lower back—caused by repetitive movements while digging. Still another object of the invention is to provide an inexpensive, no—nonsense, long-lasting and simple shovel with an easily replaceable blade.

The immediate advantage of the present invention is the harnessing of the power of a fluid to decrease significantly the amount of work involved in digging by hand, speeding up the hand-digging process and increasing the comfort of a digger.

### BRIEF DESCRIPTION OF THE DRAWINGS

FIG. 1 is a plan view of the jet shovel of the present invention with the fluid conduit not shown for clarity.

FIG. 2 is a side view of the jet shovel of the present invention showing the fluid conduit inside the shovel handle and the fluid conduit outlet nozzle.

### DETAILED DESCRIPTION OF THE INVENTION

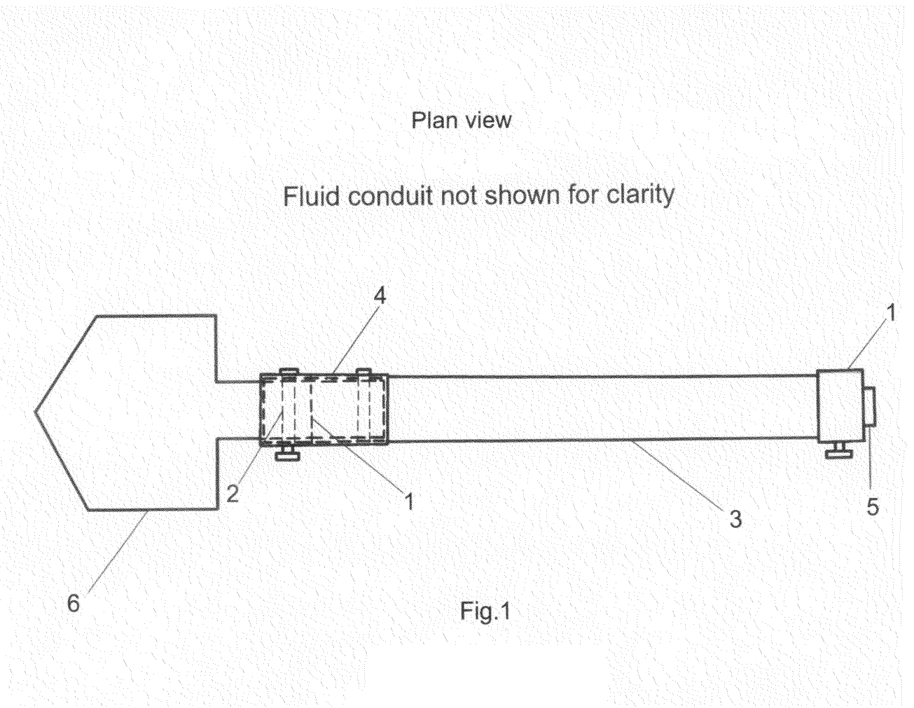

Referring to the drawings FIG. 1 represents the plan view of the fluid-powered shovel which is intended to move soil and rocks by hand-digging, especially from inside deeper trenches and other excavations.

The shovel depicted in FIG. 1 includes a shovel blade 6, a shovel blade holder bolt 2, a shovel blade holder 4, fluid control valves 1, a shovel handle 3 and a fluid inlet 5.

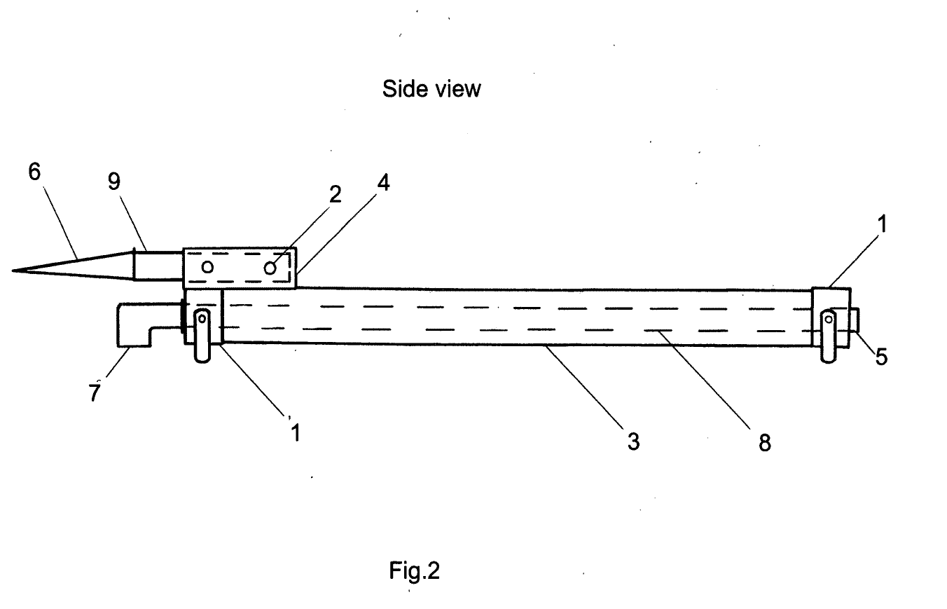

FIG. 2 represents the side view of the fluid-powered shovel with a shovel blade 6, a shovel blade handle 9, a shovel blade handle bolt 2, a shovel blade holder 4, a fluid conduit outlet nozzle 7, a shovel handle 3, a fluid conduit 8, a fluid inlet 5 and fluid control valves 1.

The opening of the valves allows the externally supplied fluid to enter the fluid conduit 8 and to travel the whole length of the conduit before exiting through the fluid conduit outlet nozzle 7 which must be directed away from the shovel blade 6. The force of the escaping fluid

### DETAILED DESCRIPTION OF THE INVENTION

pushes the fluid conduit outlet nozzle 7 in the direction of the shovel blade 6 providing the force necessary to move the shovel blade end of the shovel in the direction opposite to the direction of the escaping fluid. It is understood that the described invention is not limited to the present embodiment—it also encompasses any and all embodiments within the scope of the claims pertaining to it.

What I claim as my invention is:

1. The valved fluid conduit smaller than the diameter of the shovel handle run along the length of the said handle and ending with an outlet directed away from the shovel blade and placed in the immediate proximity thereof.

2. The valved fluid conduit serving as the shovel handle ending with an outlet directed away from the shovel blade and placed in the immediate proximity thereof.

3. The shovel blade holder placed parallel and next to the shovel handle permitting replacement of shovel blades of the tool without the need to replace the whole shovel.
